(19) United States
(12) Patent Application Publication
(10) Pub. No.: US 2007/0133356 A1
(43) Pub. Date: Jun. 14, 2007

(54) Alarm system with a plurality of interactive alarm units

(75) Inventor: Timothy Alan O'Connor, Delta (CA)

Correspondence Address: ROBERTS, MLOTKOWSKI & HOBBES, P. O. BOX 10064, MCLEAN, VA, 22102-8064, US

(73) Assignee: Zip Alarm Inc., Delta (CA)

(21) Appl. No.: 11/297,099

(22) Filed: Dec. 8, 2005

(51) Int. Cl. G04B 21/00

(52) U.S. Cl. 368/243

(57) ABSTRACT

An alarm system is formed of a network of alarm units that interact with each other to form a neighborhood watch type of alarm network. Each alarm unit transmits its own alarm condition and separately transmits its own user data to other alarm units in the network and in turn receives data from other alarm units in the network representative of their user data and alarm condition. Preferably, the data is transmitted through modulated radio frequency signals. The units in the network rebroadcast their data to maintain the database in each unit up to date. Units may be automatically added and removed without assistance from other users.

### BACKGROUND OF THE INVENTION

1. Field of the Invention

This invention relates to alarm systems, particularly those systems adapted to function in a neighborhood watch type of configuration.

2. Discussion of Related Art

Conventional home security systems rely on companies to monitor alarm conditions and alert appropriate authorities. Typically, a home will have a security system that includes various combinations of condition sensors, including for example door and window sensors, motion detectors, glass break detectors, smoke and heat sensors, and moisture sensors. When the sensors are activated, by opening a door, for instance, a signal is sent to the monitoring company, which then ascertains whether a request for assistance should be sent to the local police department. Some systems automatically send signals to the local police, fire or ambulance services. Existing alarm companies depend on the phone line to send or receive signals, making them susceptible to tampering.

It is common in households to experience false alarms, either due to a homeowners accidental tripping of the alarm, a sensed condition that does not rise to the level of an emergency or a malfunction of a particular sensor. As false alarms are common, sometimes the authorities are unnecessarily called to a home, which wastes valuable resources and can cause the homeowner to incur fines in some jurisdictions. Due to numerous false alarms, it can at times be difficult to receive adequate or timely response from the authorities when actually necessary.

A homeowner's neighbors are the closest and perhaps most reliable resource for quickly responding to an emergency and accurately assessing the seriousness of an alarm condition. This concept is well embraced and has been formalized in many areas as neighborhood watch systems. In these set ups, neighbors assume the responsibility to watch for problems within their neighborhood and either deal with them internally or reach out to the authorities only when appropriate.

This concept has been applied to household alarm systems. In some systems, neighbors monitor each others' alarm systems to provide an immediate response and to contact the authorities when a serious alarm condition is present in a neighbor's home. A problem with such self-monitoring systems is how to accurately maintain the database of neighborhood information, especially in areas where there is a high transient population. New neighbors need to be easily added, while old neighbors need to be deleted, in order to keep the watch accurate. There is also the problem of how to effectively and quickly communicate with a number of different neighbors that may or may not be physically near each other.

Some prior art systems have attempted to use the idea of a radio transmission neighborhood watch network. For example, U.S. Pat. No. 5,686,886 is directed to a watch circuit system including multiple alert units 100 that have visual indicators or light bulbs 101 adjacent separate address labels 102 for each alert unit in the system. The unit includes three switch buttons 107, 108, 109 for different types of emergencies. The buttons flash to display an alarm and are selectable for transmitting different and preprogrammed fixed coded pulsed signals for each type of emergency to the other alert units in the watch circuit. The signals are transmitted by radio wave, and a radio wave frequency signal can be preset at the same frequency setting on the units in the circuit.

U.S. Pat. No. 5,386,209 is also directed to a cluster of alarm units adapted to cooperate by radio transmission with a plurality of other such units. Each unit has a radio transmitter and a receiver connected to a common antenna. Each unit must be uniquely identified by manipulating a five digit jumper switch. A series of alarm transducers or sensors are coupled to the alarm unit by signal cables. In use, the sensors sense an alarm condition or event, which is transmitted through the signal cables to initiate the control circuitry and transmitter to transmit a coded message with the identification code set in the jumper switch. The other alarm units in the cluster, as well as the local alarm unit, receive the transmission and decode it. An LED display and audio alarm signal the alarm and indicate which unit initiated the alarm and the type of alarm. Four alarms can be displayed along with the time and date of the alarms.

In these prior art systems, each unit or member of the neighborhood watch must coordinate with the other members to join the network and configure their unit to have its unique identifier. If a member moves or otherwise leaves the network, every other member must remove that information from that system and figure out which identifier is open to new users. The prior art systems do not provide for easy and accurate maintenance of up to date information or adequately address security of transmissions.

There is a need for a system that is accurate and easy to maintain for a network of users.

### BRIEF SUMMARY OF THE INVENTION

An aspect of the embodiments of this invention is to provide a system that automatically updates user data to ensure accurate information.

Another aspect of the embodiments of this invention is to provide a system that can be joined or left without any action required of other users.

A further aspect of embodiments of the invention is to provide an easily transportable unit for use in various areas of the home or within another network.

Aspects of embodiments of the invention relate to an alarm unit, comprising a housing supporting a display; a controller connected to the display, including a memory; and, an input connected to the controller that accepts data for storage in the memory. A condition sensor retained in the housing and connected to the controller generates a signal based on a sensed condition, and the signal is sent to the controller. A signal transmitter connected to the controller transmits data from the controller to another alarm unit based on first signals from the condition sensor and separately transmits data from the controller to another alarm unit based on second signals representative of the data stored in the memory from the input. A signal receiver connected to the controller receives data from another alarm unit for storage in the memory, wherein the received data includes data stored in a memory of the other alarm unit and data representative of signals from a condition sensor in the other alarm unit. The display selectively displays the received data. An antenna connected to the signal transmitter and the signal receiver sends data from the controller and receives data from the other alarm unit. A power source is connected to the controller.

The controller can instruct the signal transmitter to transmit data from the memory on demand, at periodic intervals, or in response to data received from the signal receiver.

The signal transmitter also retransmits data received by the signal receiver. The controller includes a counter that controls the retransmission of data.

Aspects of embodiments of the invention are also directed to a network of a plurality of interactive alarm units, wherein each alarm unit comprises a display; a controller connected to the display, including a memory; an input connected to the controller that accepts data for storage in the memory; and, a condition sensor connected to the controller that generates a signal based on a sensed condition, the signal being sent to the controller. A signal transmitter connected to the controller automatically transmits data from the controller based on signals from the condition sensor and based on data stored in the memory from the input. A signal receiver connected to the controller automatically receives data from another alarm unit in the network for storage in the memory, the data including both signals from the condition sensors of other alarm units and data stored via the input in other alarm units. The display selectively displays data stored in the memory and data representative of signals received by the signal receiver. An antenna connected to the signal transmitter and the signal receiver sends data from the controller and receives data from other alarm units in the network. The controller instructs the signal transmitter to transmit data from the memory on demand, at periodic intervals, or in response to data received from the signal receiver.

Each alarm unit can further include a signal modulator and a signal demodulator so that the alarm units can send coded signals within the network.

The invention additionally relates to a method of maintaining a database in a network of a plurality of alarm units, wherein the database includes data relating to the identification of each alarm unit in the network. The method comprises establishing a network identifier; establishing a user identifier for each alarm unit; inputting user data corresponding to a particular user identifier into a first alarm unit relating to that user's name, location and/or telephone number; transmitting the user data from the first alarm unit to at least a second alarm unit; receiving the user data from the first alarm unit with at least the second alarm unit; storing the transmitted user data in the second alarm unit for subsequent access; inputting user data corresponding to a particular user identifier into the second unit relating to that user's name, location and/or telephone number; transmitting the user data from the second alarm unit to at least the first alarm unit; receiving the user data from the second alarm unit with at least the first alarm unit; storing the transmitted user data in the first alarm unit for subsequent access; and retransmitting user data by each alarm unit in the network and storing retransmitted user data in each alarm unit so that current user data is stored in each alarm unit in the network.

The method can be used in combination with a method of transmitting a signal throughout the network that is representative of an alarm condition in one of the alarm units.

These and other aspects of the invention will become apparent when taken in conjunction with the detailed description and appended drawings.

### BRIEF DESCRIPTION OF THE DRAWINGS

The invention will now be described in conjunction with the accompanying drawings in which:

FIG. 1 is a schematic diagram of a network of users in accordance with the system embodied by the invention;

FIG. 2 is a front view of a version of an alarm unit in accordance with the invention;

FIG. 3 is a side view of the alarm unit shown in FIG. 2;

FIG. 4 is flow chart showing the general process when an alarm unit is actuated and the interaction with other alarm units in the network; and,

FIG. 5 is a flow chart showing three possible scenarios involved in updating the network database.

In the drawings, like reference numerals indicate corresponding parts in the different figures.

### DETAILED DESCRIPTION OF PREFERRED EMBODIMENTS

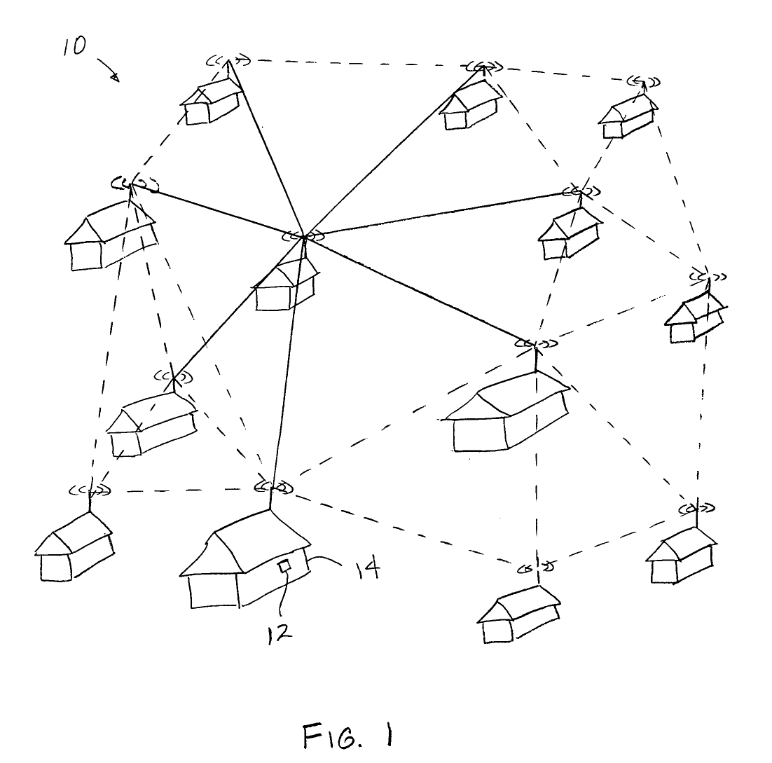

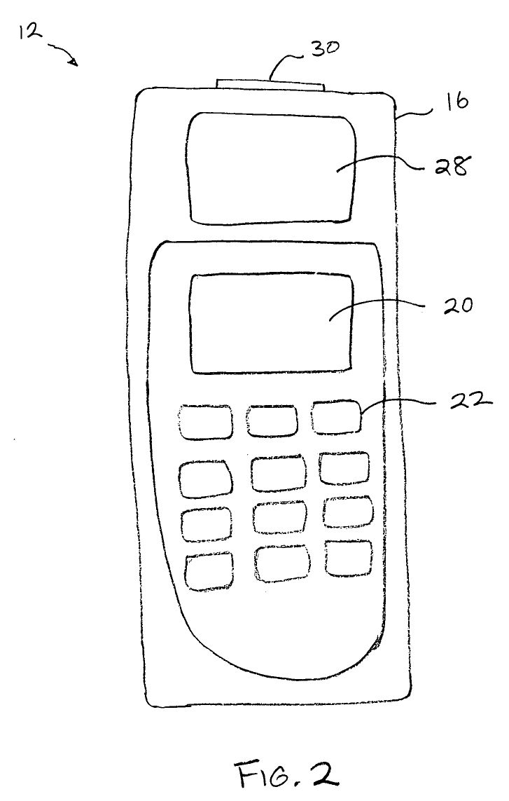

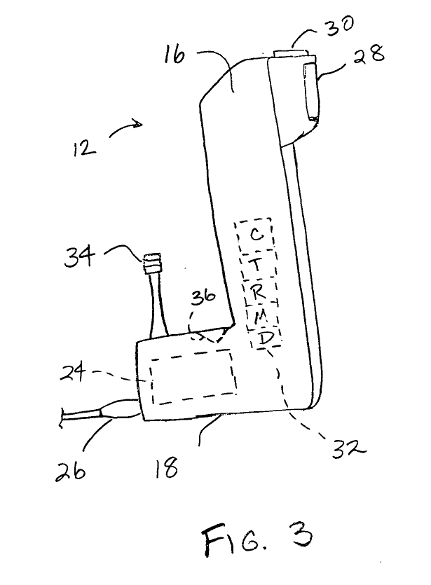

This invention is directed to a network 10 of alarm units 12, as schematically represented in FIG. 1. Each alarm unit 12, seen in detail in FIGS. 2 and 3, can be positioned at a separate location. For example, alarm units 12 may be positioned in premises 14 that are in relatively close proximity, throughout a neighborhood for instance. The network 10 is a stand alone system that can be networked with any number of alarm units 12. In a preferred arrangement, the alarm units 12 may range from 2 to 256 units per network 10, for reasons explained below.

Each unit 12 has a housing 16 that forms a free standing portable unit with a built in base 18. The front of the housing 16 supports a display 20 and a keypad 22. The display 20 is preferably back lit and can be a liquid crystal display (LCD) or any easily visible lighted display device. It may display icons relating to power and transmission along with user and alarm information, including past alarm information. The keypad 22 is also preferably lit for ease of use and can be any known type of keypad, including a touch pad, buttons or keys. The housing 16 contains the power source, such as a rechargeable battery pack 24 and an AC connector 26. Of course, if desired, the unit 12 could run on any type of battery or with electric current as is known.

Each alarm unit 12 has a condition sensor for sensing and signaling an alarm condition. In a preferred embodiment, the condition sensor is a motion detector type sensor 28, such as a passive infrared detector. For instance, a dual element LHI 878 pyroelectric infrared detector positioned behind a fresnel lens may be used. The alarm unit 12 seen in FIGS. 2 and 3 also has a panic button 30 for manual activation upon a medical or other emergency. The panic button may be a lighted mechanical switch contact. If desired other types of condition sensors may be added to the unit 12, including additional wireless motion sensors, smoke detectors, gas or carbon dioxide detectors, temperature monitors, moisture or flood detectors, and car intrusion detectors.

The housing 16 contains the system components, shown generically in FIG. 3 as element 32. The system components include a controller C with a memory, a signal transmitter T connected to the controller, and a signal receiver R connected to the controller that receives data from another alarm unit. The controller C may be any known type of controller, such as a micro-controller. The memory can be any know type of storage tool, such as a look up table. The signals are preferably transmitted and received through an antenna 34 via radio frequency (rf) signals. The signal transmitter T can be an internal radio modem with any desired range, for example 700 meters. The signal transmitter T transmits data from the controller C to another alarm unit 12 based on signals from the condition sensors 28, 30 and based on data stored in the memory from the input 22. The signal receiver R is also connected to the controller C and receives data from other alarm units 12 for storage in the memory. The received data can include data stored in a memory of the other alarm units 12 and data representative of signals from condition sensors 28, 30 in the other alarm units. It is additionally contemplated that the unit 12 can be adapted to wirelessly transmit a signal to a peripheral device, such as a computer or phone.

Preferably, the system components also include a signal modulator M connected to the signal transmitter T and a demodulator D connected to the signal receiver R so that the unit 12 can send and receive coded signals. For example, the modulator M may use an encryption device, such as Serpent, which is a public domain block cipher, to encrypt all transmissions to and from each unit on the same network 10, to provide banking quality security to eliminate the possibility of signals being intercepted and decoded or tampered with by parties outside of the network.

The network 10 uses a network identification (ID) and a network password. The network ID and password provide a high level of security in each network thereby restricting access to only those users that are authorized to join. The network ID and password are also used to generate the encryption key within each unit. Transmitting encrypted data between units 12 on each network prevents overlap between different networks that may be in close proximity to each other or overlapping each other.

To set up the network 10, a network ID, such as a 3 digit number, and a network password, such as a 4 digit number, are selected. Upon joining the network, the user is assigned a unique individual network member identification number. Each user then selects a user code, which is used to arm and disarm each user's individual unit 12 as desired. Each user then enters his or her name, address and telephone number, or some other identifying data, into their unit 12. A preset delay period chosen by the user is also entered via the input 22 to allow a user to select the period of time within which a disarm signal can be sent before activating other units 12 within the network 10 in response to certain types of alarms. For example, the delay may be omitted when the panic button is activated. The data is stored in the memory of the controller C. Each user's data is wirelessly passed from unit to unit so that all user data is stored in each unit's memory. So, each user only needs to enter his or her own data via their unit's input 22.

To join an established network 10, a user merely obtains the network ID and password for that particular network 10, selects a user code, and enters his or her identifying data. The data is then pushed to the other units and stored in their memory as described below. As noted above, the new user is also assigned a unique individual network member identification number.

The network 10 is preferably a “mesh network” communication link in which each unit 12 communicates with all of the other units 12 within radio range (point to multipoint transmission), as schematically illustrated by the solid lines in FIG. 1. Units 12 can also communicate with units outside of the immediate radio range by hopping data through units that are in direct radio range, as schematically illustrated by the dashed lines in FIG. 1. By this, the network range can be extended.

To increase the reliability of the radio link between units 12 in a network 10, each unit 12 is synchronized to periodically change its operating frequency according to a predetermined pattern. This minimizes the effects of rf noise and interference from other devices operating on nearby frequencies. It also ensures that each unit in a network 10 is using the same frequency at a given time.

In operation, when a condition sensor senses an emergency condition in a unit 12, an rf signal is immediately transmitted from the signal transmitter T through the antenna 34 to other units 12 in the network 10. After receiving the signal, the other units wait for the time period set by the user from the unit that has been activated, if appropriate for that type of signal, before displaying alarm information or activating the audible alarm. During this time, the unit 12 experiencing the alarm condition may be deactivated by the user entering the user code into the input 22, thereby canceling the alarm. It is not possible for a third party to deactivate the unit 12 by canceling or interfering with the alarm by disabling or disconnecting the unit 12 because the signal is sent immediately upon sensing the alarm condition and will be displayed in other units unless the deactivation signal is sent by the user.

Since the alarm is sent to users within the network that include premises in close proximity to the unit 12 sounding the alarm, neighbors can be immediately alerted to the emergency or possible break in. When the alarm signal is received by the signal receiver R, each unit 12 receiving the signal activates its display 20 to show the user identification, such as name, address, and phone number, and the type of alarm. Of course, the display can be configured to show any type of information from a simple user code to detailed user information. The units 12 also include a noise emitting device 36 that is activated when an alarm condition is signaled along with lighting the display and panic button. The noise emitting device 36 may be a siren that is controlled by a 556 timer, for instance, to generate a two tone alarm and provide low and high volume sound. By this, the low volume can be activated by units receiving the broadcast and the high volume can be activated by the unit initiating the alarm. The neighbors or other users in the network 10 can then take action to determine the validity of the alarm and contact the proper authorities if necessary.

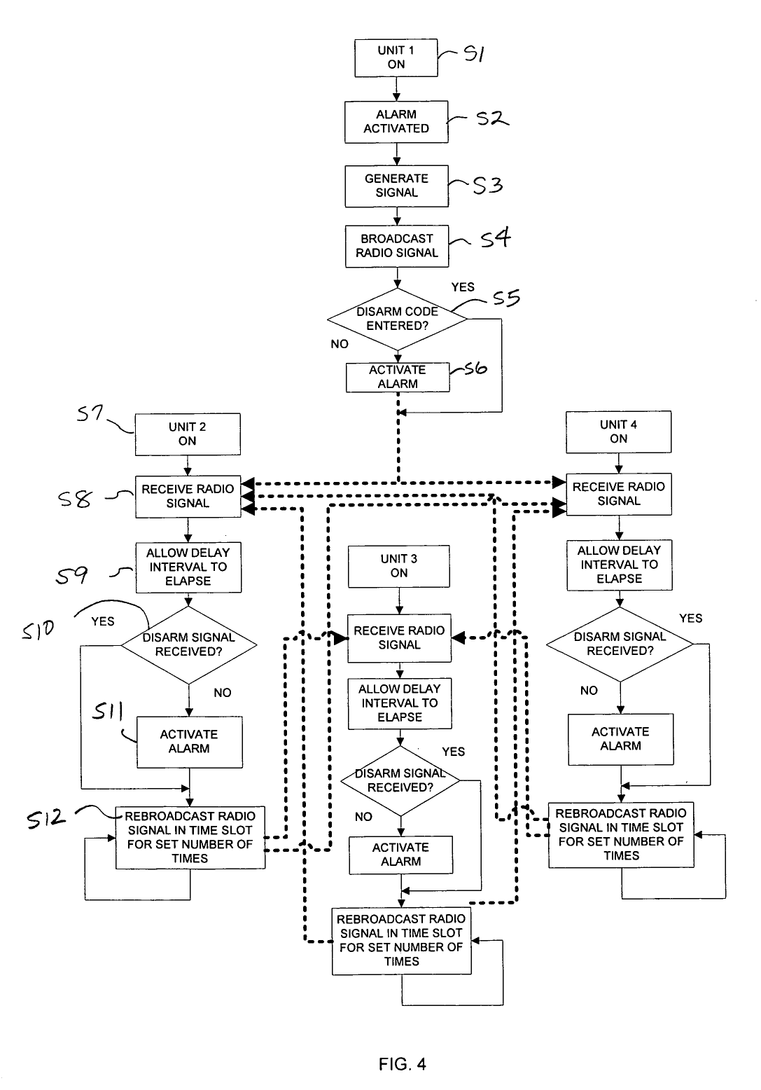

Referring to FIG. 4, the steps relating to sensing and transmitting an alarm are shown. At S1 (step 1), a first unit 1 is in an ON state. When a condition sensor, such as a motion detector 28, senses an intruder, the alarm is activated (S2) and a signal is generated (S3) at the controller C to cause the signal transmitter T to broadcast a signal through the antenna 34 to other units in the network 10 (S4), as seen in FIG. 1. If the disarm code is not entered (S5) in unit 1, the unit sounds an alarm (S6) through the audible alarm and flashes the display and panic button. If the disarm code is entered (S5) in unit 1, the disarm signal is also broadcast to other units in the network.

Unit 2, which is ON (S7), receives the radio broadcast (S8) and waits the preset delay period (S9). If the disarm signal is received (S10) within the delay period the alarm is not activated. If the disarm signal is not received (S10) within the delay period, the alarm is activated (S11) by sounding an audible alarm, activating the lights, and displaying the alarm condition and identity of unit 1. Unit 2 also rebroadcasts the alarm signal (S12) in a predetermined time slot for a predetermined number of times to other units that may and may not have received the original broadcast.

As seen in FIG. 4, unit 4 originally received the broadcast from unit 1 and executed the same steps as unit 2. Unit 3, however, did not receive the signal until it was rebroadcast from units 2 and 4. This is an example of hopping the signal within the network.

As noted above, each unit 12 is assigned a unique individual network member identification number. This number is used to organize transmission of events through the network. The network 10 is based on fixed linear time division protocol so each unit has a defined time slot for transmission based on its network member identification number. The transmit cycle consists of 256 time slots, which in this case controls the maximum number of units per network. Each unit is permitted to rebroadcast (or hop) only a fixed number of times without an acknowledgement to prevent data storms. Using this protocol, a unit that receives a rebroadcast, such as unit 3 in the example above, sets its transmission timer based on which units it received the rebroadcast from. Then, that unit will rebroadcast in its pre-allotted time slot (e.g., in the time slot for unit 3.)

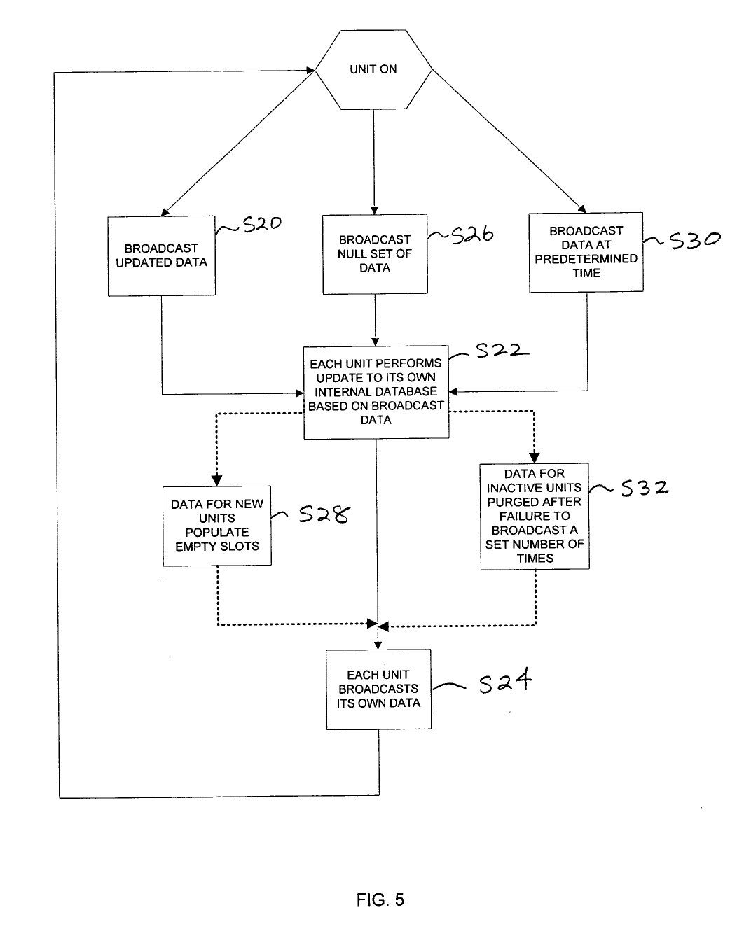

FIG. 5 shows several methods for maintaining the database in each unit 12. As noted above, the controller C in each unit 12 has a memory, preferably in the form of a look up table, that stores user data, including member identification numbers, names, addresses, and phone numbers, for every unit in the network 10. By this, it is only necessary to transmit minimal data between units upon activation of an alarm event, while still allowing each unit to access all of the relevant information relating to each particular user when appropriate.

To maintain a current database for every user, the database in each unit 12 is updated on demand and at regular intervals. When data is changed in a particular unit through the input 22, an on demand update (S20) is initiated in which the updated unit broadcasts its new data to all of the other units in the network 10. Each receiving unit updates its database (S22) and forwards the data (S24) in the same way alarm messages are broadcast. So, if a user changes a phone number, for example, the new phone number merely needs to be input through the keypad 22 and it will be automatically stored and broadcast to the other units for storage.

If a new unit 12 joins the network 10, a null set of data is broadcast (S26). This causes the other units to perform an update (S22) and broadcast their data (S24), which is then stored in the new unit. After the new unit's database is populated, it claims the next empty member identification number as its own (S28). This addition to the memory causes a broadcast of its updated data (S24 and S20), which in turn causes the other units to perform an update (S22) and broadcast (S24). By this, all other units in the network 10 and the new user are updated.

To purge inactive units and ensure that the database is up to date, periodic broadcasts are also performed (S30). A random time each day or some other time period is set for broadcasting data and performing updates based on any new data. A counter is associated with each database entry. When a unit performs an interval update, all the counters are incremented. When a unit receives a broadcast from another unit, the counter is zeroed for the database entry for that unit. If a counter associated with any entry reaches a predetermined number, 10 for example to represent 10 days of inactivity, the entry is determined to be stale and is purged from each unit's database (S32). By this, users who leave the network are automatically deleted from the database without other user's intervention.

It can be seen that each unit 12 is entirely self contained and powered by standard house current, if desired, with no additional wiring. The units 12 are portable and can function at any location with battery power. In the event of a power failure or an intentional power disconnection, the units will continue to operate. The current battery level can be shown on the display 20, along with other operations icons. Different modes of operation to conserve battery power can also be implemented, such as limiting communication to transmission while restricting receipt and display of alarms.

Various modifications can be made in my invention as described herein, and many different embodiments of the device and method can be made while remaining within the spirit and scope of the invention as defined in the claims without departing from such spirit and scope. It is intended that all matter contained in the accompanying specification shall be interpreted as illustrative only and not in a limiting sense.

What is claimed is:

1. An alarm unit, comprising:
a housing supporting a display;
a controller connected to the display, including a memory;
an input connected to the controller that accepts data for storage in the memory;
a condition sensor retained in the housing and connected to the controller that generates a signal based on a sensed condition, the signal being sent to the controller;
a signal transmitter connected to the controller that transmits data from the controller to another alarm unit based on first signals from the condition sensor and separately transmits data from the controller to another alarm unit based on second signals representative of data stored in the memory from the input;
a signal receiver connected to the controller that receives data from another alarm unit for storage in the memory, wherein the received data includes data stored in a memory of the other alarm unit and data representative of signals from a condition sensor in the other alarm unit, and wherein the display selectively displays the received data;
an antenna connected to the signal transmitter and the signal receiver that sends data from the controller and receives data from the other alarm unit; and
a power source connected to the controller.

2. The alarm unit of claim 1, wherein the signal transmitter automatically transmits data based on the first signals in response to a sensed condition and selectively transmits data based on the second signals.

3. The alarm unit of claim 1, wherein the controller instructs the signal transmitter to transmit data from the memory on demand, at periodic intervals, or in response to data received from the signal receiver.

4. The alarm unit of claim 1, wherein the signal transmitter also retransmits data received by the signal receiver.

5. The alarm unit of claim 4, wherein the controller includes a counter that controls the retransmission of data.

6. The alarm unit of claim 1, wherein the power source is an electrical power connection.

7. The alarm unit of claim 1, wherein the power source is a battery.

8. The alarm unit of claim 1, further comprising a signal modulator connected to the signal transmitter and a demodulator connected to the signal receiver so that the unit can send and receive coded signals.

9. The alarm unit of claim 1, wherein the display is a liquid crystal display.

10. The alarm unit of claim 1, wherein the display includes a light and alphanumeric symbols.

11. The alarm unit of claim 1, wherein the input is a touch pad supported on the housing.

12. The alarm unit of claim 1, wherein the input is a keyboard.

13. The alarm unit of claim 1, wherein the condition sensor includes a manually activated panic button.

14. The alarm unit of claim 1, wherein the condition sensor is a motion detector supported by the housing.

15. The alarm unit of claim 1, wherein the condition sensor is a switch supported in the housing.

16. The alarm unit of claim 1, wherein the condition sensor includes at least one of a panic button, a motion detector, a door sensor, a window sensor, a smoke detector, and a moisture sensor.

17. The alarm unit of claim 1, wherein the memory is a look up table.

18. The alarm unit of claim 1, wherein the memory is remotely accessible.

19. The alarm unit of claim 1, wherein the controller is remotely programmable.

20. The alarm unit of claim 1, in a network defined by a plurality of the alarm units, such that the signal transmitters and signal receivers communicate with each other and the memories store data representative of each alarm unit in the network.

21. A network of a plurality of interactive alarm units, wherein each alarm unit comprises:
a display;
a controller connected to the display, including a memory;
an input connected to the controller that accepts data for storage in the memory;
a condition sensor connected to the controller that generates a signal based on a sensed condition, the signal being sent to the controller;
a signal transmitter connected to the controller that automatically transmits data from the controller based on signals from the condition sensor and based on data stored in the memory from the input;
a signal receiver connected to the controller that automatically receives data from another alarm unit in the network for storage in the memory, the data including both signals from the condition sensors of other alarm units and data stored via the input in other alarm units, wherein the display selectively displays data stored in the memory and data representative of signals received by the signal receiver; and
an antenna connected to the signal transmitter and the signal receiver that sends data from the controller and receives data from other alarm units in the network,
wherein the controller instructs the signal transmitter to transmit data from the memory on demand, at periodic intervals, or in response to data received from the signal receiver.

22. The network of claim 21, wherein each alarm unit further includes a signal modulator and a signal demodulator so that the alarm units can send coded signals within the network.

23. A method of maintaining a database in a network of a plurality of alarm units, wherein the database includes data relating to the identification of each alarm unit in the network, comprising:
establishing a network identifier;
establishing a user identifier for each alarm unit;
inputting user data corresponding to a particular user identifier into a first alarm unit relating to that user's name, location and/or telephone number;
transmitting the user data from the first alarm unit to at least a second alarm unit;
receiving the user data from the first alarm unit with at least the second alarm unit;
storing the transmitted user data in the second alarm unit for subsequent access;
inputting user data corresponding to a particular user identifier into the second unit relating to that user's name, location and/or telephone number;
transmitting the user data from the second alarm unit to at least the first alarm unit;
receiving the user data from the second alarm unit with at least the first alarm unit;
storing the transmitted user data in the first alarm unit for subsequent access; and
retransmitting user data by each alarm unit in the network and storing retransmitted user data in each alarm unit so that current user data is stored in each alarm unit in the network.

24. The method of claim 23, wherein retransmitting user data occurs on demand.

25. The method of claim 23, wherein retransmitting user data occurs at periodic intervals.

26. The method of claim 23, wherein the steps of transmitting and retransmitting occur by broadcasting radio signals.

27. The method of claim 23, wherein the step of transmitting user data from an alarm unit newly added to the network includes transmitting a null set of data.

28. The method of claim 23, wherein the step of storing retransmitted data includes purging user data after failure of a user to retransmit data after a predetermined period.

29. The method of claim 23, in combination with a method of transmitting a signal throughout the network that is representative of an alarm condition in one of the alarm units.

30. The method of claim 29, wherein transmitting the signal representative of an alarm condition includes transmitting a signal directly from the alarm unit experiencing the alarm condition and transmitting a signal received from a different alarm unit that received the signal from the alarm unit experiencing the alarm condition.
